(19) United States
(12) Patent Application Publication
(10) Pub. No.: US 2016/0022377 A1
(43) Pub. Date: Jan. 28, 2016

(54) COMBINED USE OF ULTRASOUND WITH NICKEL TITANIUM ENDODONTIC FILE IN ENDODONTIC PROCEDURE

(71) Applicant: ULTRADENT PRODUCTS, INC., South Jordan, UT (US)

(72) Inventors: Carlos Alberto Spironelli Ramos, South Jordan, UT (US); Richard D. Tuttle, Layton, UT (US)

(21) Appl. No.: 14/775,444

(22) PCT Filed: Mar. 14, 2014
(86) PCT No.: PCT/US14/28406

§ 371 Date: Sep. 11, 2015

Related U.S. Application Data
(60) Provisional application No. 61/790,726, filed on Mar. 15, 2013.

(51) Int. Cl. A61C 3/03; A61C 1/12; A61C 5/02; A61C 1/07; A61C 1/14

(52) U.S. Cl. CPC A61C 3/03; A61C 1/07; A61C 1/148; A61C 1/144; A61C 5/023; A61C 1/12

(57) ABSTRACT

Methods and related systems for cleaning a root canal of a tooth employing a super-elastic NiTi endodontic file while applying ultrasonic energy during the cleaning procedure. Such a method may include inserting an endodontic file into a root canal of a tooth in which the file includes a working portion comprising a super-elastic NiTi alloy.

The root canal is cleaned by moving the working portion of the file within the root canal so that the working portion of the file cuts or abrades tissue within the root canal. Ultrasonic energy is applied to the file, tooth, or both in order to assist in breaking up and removing necrotic tissue in the root canal during cleaning. The ultrasonic energy is applied in a manner that does not result in breakage of the file for a period of at least 3 minutes. In an embodiment, a length of the exposed portion of the file is maintained at 22 mm or more to delay file breakage.

### BACKGROUND

1. The Field of the Invention

The present invention relates to methods that employ endodontic instruments in preparing a root canal of a tooth for receiving a sealer and/or filler material. More particularly, the invention relates to methods and systems for cleaning a root canal of a tooth with an endodontic file comprising a super-elastic nickel-titanium (“NiTi”) alloy with application of ultrasonic energy.

2. The Relevant Technology

When a root canal of a living tooth becomes infected or abscessed, discomfort and, in many cases, severe pain can result. In the early days of dentistry the only solution was to extract the tooth. More recently, however, dental practitioners have developed procedures for successfully removing the pulp material that includes the nerve of the tooth, which has become necrotic and/or infected. After careful preparation of the root canal that contains the nerve material, the canal is refilled with an inert filling material, such as gutta percha. This process allows the patient to retain the tooth.

To achieve a successful root canal restoration, the dental practitioner must carefully and, as completely as possible, remove the infected pulp material. The removal process typically includes shaping the root canal so that it can be effectively and successfully filled and sealed with an inert material to reduce the possibility of further infection.

Cleaning and shaping the root canal in preparation for receiving a sealing and/or filling material is achieved by the use of metal endodontic instruments that include cutting surfaces for removing tissue in the root canal. Since root canals are seldom straight, often having bends and twists, at least some endodontic instruments are flexible so as to allow the instrument to follow the curvature of the root canal. Currently preferred materials of construction include stainless steel and super-elastic NiTi alloys. Because of their excellent flexibility, NiTi files are often preferred in cleaning portions of the root canal exhibiting a high degree of curvature and tortuosity.

Another development relates to the application of ultrasonic energy to a stainless steel endodontic file while cleaning the root canal. While it has been possible to employ stainless steel files with ultrasonic powered handpieces, the use of super-elastic NiTi endodontic files with ultrasound has not been possible, as the super-elastic NiTi files will quickly break (i.e., within a few seconds) when subjected to ultrasonic energy. Failure of any type of endodontic file within a root canal of a tooth, particularly where the broken distal end of the file is engaged within root canal tissue, can be disastrous or catastrophic, resulting in a broken instrument fragment that can become tightly lodged within the root canal. Broken instrument fragment removal is very difficult, and sometimes impossible without loss of the tooth.

It would be an improvement in the art to provide methods and systems that allow combined use of ultrasonic treatment with super-elastic NiTi endodontic files in cleaning a root canal, while minimizing risk of file breakage within the root canal. Such methods and systems would allow ultrasonic endodontic cleaning with not only stainless steel files, which are significantly stiffer than super-elastic NiTi files, but would provide the benefits of ultrasonic endodontic treatment in cleaning portions of root canals that are heavily curved.

### BRIEF SUMMARY

According to one aspect, the present invention is directed to method for cleaning a root canal of a tooth that employ both a NiTi super-elastic endodontic file and application of ultrasonic energy in a manner that surprisingly does not result in breakage of the NiTi super-elastic endodontic file. Such a method may include inserting an endodontic file into a root canal of a tooth, the endodontic file including a working portion comprising a super-elastic NiTi alloy. The root canal is cleaned by moving the working portion of the endodontic file within the root canal so that the working portion of the file cuts or abrades tissue within the root canal. Ultrasonic energy is applied to the endodontic file, the tooth, or both in order to assist in breaking up and removing necrotic tissue in the root canal of the tooth. Application of ultrasonic energy to the NiTi file in the manner disclosed herein does not result in breakage of the endodontic file for a period of at least 3 minutes.

Another aspect involves a method for cleaning a root canal of a tooth comprising coupling an endodontic file with a chuck of an ultrasonic powered handpiece assembly so that an exposed portion of the endodontic file extends at least 22 mm beyond the chuck. The endodontic file includes a working portion comprising a super-elastic NiTi alloy. At least a portion of the exposed portion of the endodontic file is inserted into a root canal of a tooth, and the root canal is cleaned by moving the working portion of the endodontic file within the root canal so that the working portion of the endodontic file cuts or abrades tissue within the root canal. Ultrasonic energy is applied to the endodontic file in order to assist in breaking up and removing necrotic tissue in the root canal of the tooth, and application of the ultrasonic energy does not result in breakage of the endodontic file for at least 3 minutes.

The inventor has unexpectedly found that when a NiTi endodontic file is coupled into an ultrasonic powered handpiece, and the file is coupled in a manner that provides at least 22 mm of exposed length, the NiTi file does not quickly break upon application of ultrasonic energy as normally occurs when applying ultrasonic energy to a NiTi file. Without wishing to be bound by any particular theory, it is postulated that lengths shorter than 22 mm allow the natural resonance frequency of the NiTi file to be more quickly and efficiently excited, resulting in formation of harmonic waves that quickly cause breakage of the file. It is postulated that where the exposed length of the NiTi file is maintained to be at least 22 mm, excitation of the natural resonance frequency of the NiTi file is limited or otherwise impaired, allowing the super-elastic file to be used with an ultrasonic powered handpiece without immediate breakage. Such a result is surprising and unexpected, as although stainless steel files can be routinely used with ultrasonic powered handpieces, up to now it has been impossible to employ a super-elastic endodontic file in an ultrasonic powered handpiece without almost immediate in-canal breakage, as the file quickly shatters or otherwise breaks as a result of application of the ultrasonic energy.

Another aspect of the present invention is directed to a system for use in a method for cleaning a root canal of a tooth while employing a super-elastic NiTi endodontic file and an ultrasonic powered handpiece, while preventing breakage of the NiTi file for a sufficiently long period (e.g., 3 minutes) to allow its use. Such a system includes a connector for use with an ultrasonic powered handpiece, the connector including a chuck at a distal end for coupling an endodontic file into the connector. The system also includes at least one endodontic file including a working portion comprising a super-elastic nickel-titanium alloy, the endodontic file being coupleable into the chuck of the connector so that an exposed portion of the endodontic file extending beyond the chuck is at least 22 mm in length when the file is coupled with the chuck.

Application of ultrasound energy to an endodontic file as disclosed herein can also “activate” debriding and cleaning agents. Cleaning and debriding agents work better when they are agitated because “fresh” or “non-reacted” material is caused to more intimately interact with the endodontic surfaces being treated. Such activation occurs when using NiTi endodontic files and also occurs when using other endodontic files, such as stainless steel files. Ultrasonic vibration of endodontic files can facilitate penetration of chemical agents into spaces, crevices and pores within a root canal.

These and other benefits, advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a cross-sectional view through a tooth;

FIG. 2 is a cross sectional view similar to that of FIG. 1, showing insertion of an NiTi file into the root canal while ultrasonic energy is applied thereto according to an embodiment of the present invention;

FIG. 3 is an perspective view of a NiTi endodontic file coupled into an exemplary ultrasonic powered handpiece assembly including a connector and ultrasonic powered handpiece;

FIG. 4 is a close up perspective view showing the connector that couples to an ultrasonic powered handpiece, the connector including a chuck into which a NiTi endodontic file is coupled where the chuck allows one to adjust a length of the exposed portion of the NiTi endodontic file;

FIG. 5 is a close up perspective view of a NiTi endodontic file that does not include any cutting surfaces, but is smooth, and which may be employed in the present methods; and

FIG. 6 is a close up perspective view of a NiTi endodontic file including an abraded or sand-blasted surface, and which may be employed in the present methods.

### DETAILED DESCRIPTION

### I. Introduction

The invention generally relates to methods and related systems for cleaning and shaping a root canal of a tooth employing a super-elastic NiTi endodontic file while applying ultrasonic energy during the cleaning procedure. Examples method include inserting an endodontic file into a root canal of a tooth in which the file includes a working portion comprising a super-elastic NiTi alloy. The root canal is cleaned by moving the working portion of the file within the root canal so that the working portion of the file cuts or abrades tissue within the root canal. Ultrasonic energy is applied to the file, tooth, or both in order to assist in breaking up and removing necrotic tissue in the root canal during cleaning. The ultrasonic energy is applied in a manner that does not result in breakage of the file for a period of at least 3 minutes. Related systems include apparatus for performing the inventive methods.

### II. Exemplary Methods and Systems

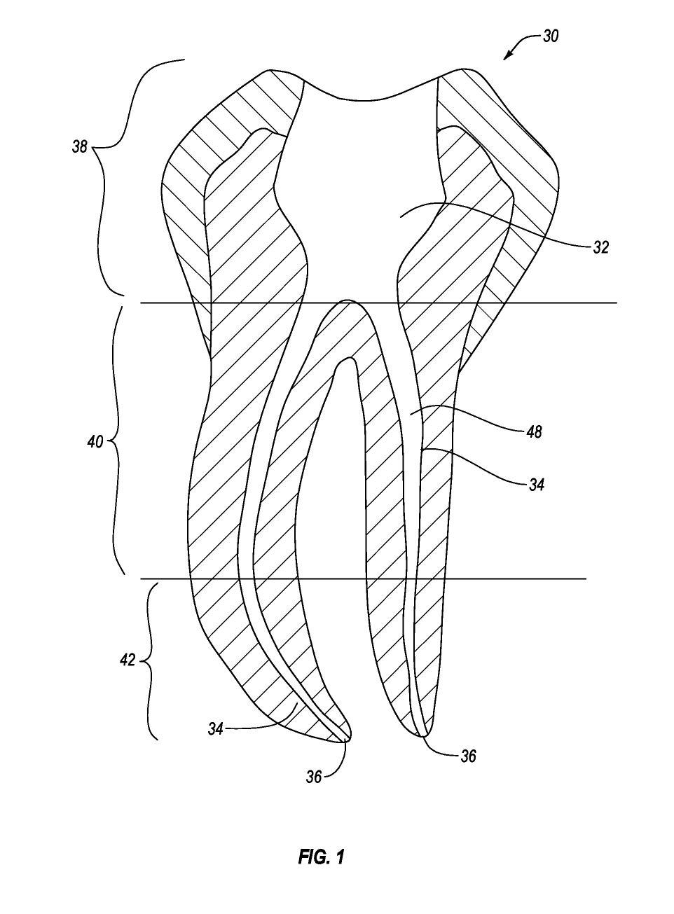

FIG. 1 shows a cross-section through an exemplary tooth 30 including two roots. According to one technique, a root canal may be cleaned in progressive sections from crown to apex. In another technique, the entire length of root canal may be cleaned using a single tool or cleaning step. Regardless of the technique, the root canal may be prepared in three phases, each phase corresponding to cleaning of one of three sections or portions of the root canal procedure. Pulp chamber 32 is connected to root canals 34, which extend from a floor of pulp chamber 32 to apexes 36. For example, the three sections or portions include coronal portion 38, middle portion 40, and apical portion 42.

The “coronal phase” typically involves exposing pulp chamber 32. This can be achieved, for example, through the use of a dental burr. Once access to pulp chamber 32 has been achieved, pulp material within chamber 32 may be removed.

After the operative coronal portion 38 has been adequately prepared, an X ray image of the tooth may be taken to identify the length of the root canal 34 to better identify the preferred working length for one or more endodontic instruments used in cleaning middle portion 40 and apical portion 42. According to one embodiment, a single file is having a length that can reach the apex can be used to clean both middle portion 40 and apical portion 42, whether starting with the middle portion 40 first and then cleaning the apical portion 42, or starting in the apical portion 42.

After identifying the root canal length, the practitioner may select an endodontic file instrument or a set of endodontic file instruments with a file length corresponding to the length of middle portion 40 or both middle portion 40 and apical portion 42. The length of each file used to clean middle portion 40 and apical portion 42 depends on the tooth being cleaned, but is generally in a range from about 20 mm to about 35 mm. During cleaning of middle portion 40, the selected endodontic file may be inserted into root canal 34 down through operative middle portion 40 without extending substantially into apical portion 42. Once substantially all pulp material is removed from operative middle portion 40, the same or different file can be used to clean apical portion 42. For example, a specially configured apical file may be used for removing the pulp within apical portion 42 when a single file used to clean both portions is not used.

Apical files may typically be formed of a super-elastic NiTi alloy so that they may more easily follow the anatomical contour of root canal 34. As described in U.S. Pat. No. 7,980,853, herein incorporated by reference in its entirety, such apical files may also include a cutting portion adjacent the distal end of the file that is limited in length so that it does not extend proximally upward the entire length of the shaft of the endodontic file, but is limited in length so as to not abrade or cut tissue which it may contact in the proximally located middle and coronal portions during cleaning of the apical portion. While described in the context of techniques by which the middle portion is cleaned separately from the apical portion, it will be understood that other techniques are also possible, e.g., one may clean middle and apical portions 40, 42 at the same time using one or more files.

Middle portion 40, and particularly apical portion 42, of root canal 34 may include portions which deviate substantially from a straight contour. Within such highly curved portions of the root canal 34, it can be difficult to clean root canal 34 in a manner that closely follows the anatomical curvature of the root. Stainless steel and NiTi are materials typically employed in file manufacture. Stainless steel files generally exhibit greater stiffness and strength as compared to NiTi files, which are substantially more flexible due to super-elastic characteristics of the NiTi alloy from which they are formed.

When attempting to clean such a highly curved portion of a root canal, there is a risk that ledging will occur. Ledging occurs when the tip of an endodontic file does not have sufficient flexibility to follow the anatomical contour of a root canal as it encounters a curve. Rather, the tip bores into the sidewall of the root canal, forming a ledge in the sidewall, which can be highly undesirable. Because of the relatively greater flexibility of NiTi endodontic files, such files are generally preferred in cleaning highly curved portions of the root canal, as they are generally less prone to ledging compared to stainless steel files.

Endodontic files are provided in configurations for manual manipulation, as well as for coupling with a chuck of a powered dental handpiece, for automated manipulation. For example, manually manipulated endodontic files may include an enlarged grippable handle at a proximal end for gripping within the practitioner's hand during cleaning. An endodontic file configured for coupling into a powered handpiece may include any of various keyed structures adjacent a proximal end, or may simply include a generally straight proximal shaft that is received into a chuck of a powered handpiece assembly.

An advantage associated with at least some powered handpieces is their ability to provide ultrasonic energy to the endodontic file. As described above, current practice limits application of ultrasound energy to stainless steel files, but does not permit combining application of ultrasound energy with the use of NiTi files, as NiTi files quickly break upon exposure to ultrasonic energy. As described above, failure of a file within a root canal can be catastrophic, as it can be difficult, if not impossible, to retrieve the broken file fragments. Thus, while the benefits of ultrasonic energy are available when cleaning root canals using a stainless steel file, any attempt to employ a NiTi with ultrasound is too risky and cannot be employed.

Moreover, because of the risk of ledging, stiffer stainless steel files are best suited for cleaning straighter portions of root canals. Use of stainless steel files in a curved root canal portion comes with increased risk of ledging. Ultrasound energy can exacerbate ledging. When attempting to navigate a highly curved root canal portion with a stainless steel file while applying ultrasonic energy, more ledging actually occurs (or the tendency to ledge is increased) than without application of ultrasonic energy. Because up to now it has not been possible to employ Ni—Ti endodontic files with ultrasonic energy without fear of immediate catastrophic in-canal breakage, standard practice dictates that, when cleaning the more curved portions of root canals using NiTi files, the procedure cannot be performed while applying ultrasound energy due to the extremely high risk of breakage. This is unfortunate because applying ultrasound energy could be very beneficial when cleaning curved root canals.

Unexpectedly, the inventor has found a method by which ultrasonic energy may be applied to a NiTi endodontic file while delaying or preventing breakage of the NiTi file so that it may be used in an endodontic procedure without fear of the file breaking during the procedure. The combined use of ultrasonic energy and NiTi files may be employed when cleaning any portion of the root canal, although it will be apparent that its use may be particularly advantageous within highly curved root canal portions, which may more typically be present in the middle portion and especially the apical portion of the root canal.

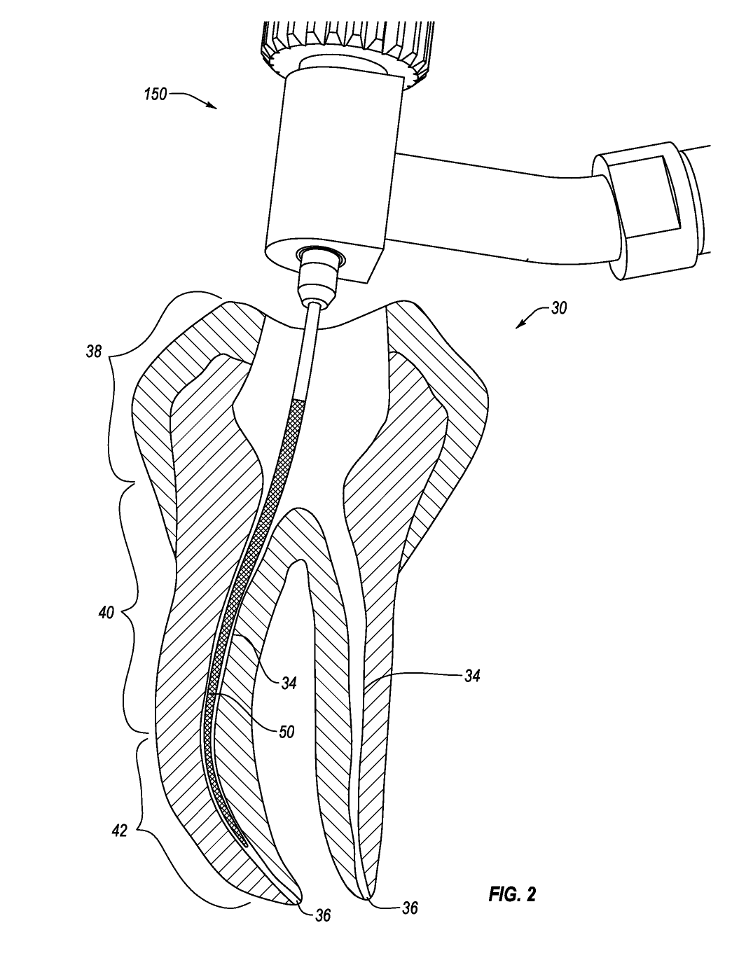

As shown in FIG. 2, combined use of ultrasound and a NiTi file 50 advantageously assists in breaking up and removing necrotic tissue from within the root canal 34, providing the advantages of ultrasound energy application when cleaning highly curved root canal portions (e.g., illustrated curved apical portion 42), which was not previously possible with the flexibility provided by NiTi file 50. In an embodiment, application of the ultrasonic energy may manifest itself as high frequency vibration of NiTi file 50, which vibration may aid in break-up and removal of debris within the root canal.

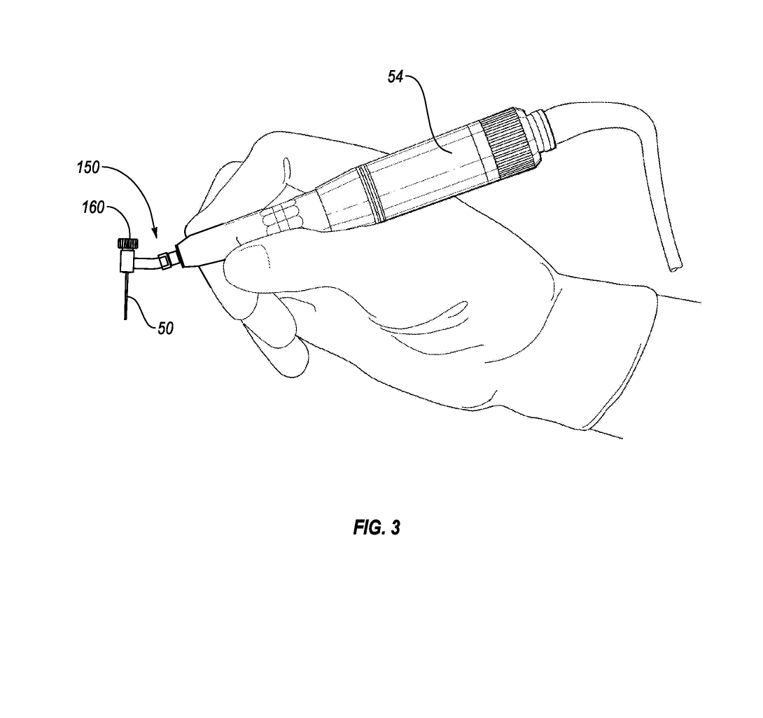

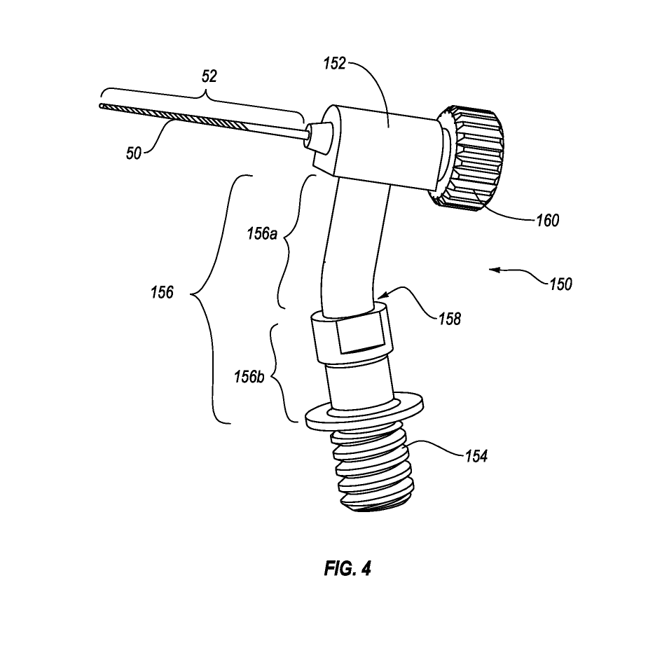

Referring to FIGS. 3 and 4, in particular, the inventor has found that by controlling the length of exposed portion 52 of the endodontic file received within the powered handpiece assembly 54, one may sufficiently retard fatigue-induced failure of NiTi file 50 to allow it to be subjected to ultrasonic energy during cleaning (e.g., while the file 50 is at least partially in contact with the walls of root canal 34) to provide at least 3 minutes, at least 4 minutes, at least 5 minutes, at least 6 minutes, at least 7 minutes, at least 8 minutes, or at least 10 minutes of use without breakage of the NiTi file in the root canal. Such periods of time of safe use allows a practitioner to complete the desired treatment or portion thereof and remove the NiTi file 50 from root canal 34 before fatigue-induced failure occurs.

In an embodiment, exposed portion 52 of the NiTi file is at least 22 mm in length, at least 23 mm in length, at least 24 mm in length, or at least 25 mm in length. As a non-limiting example, a total length of the NiTi file 50 may be at least 28 mm, at least 29 mm, at least 30 mm in length, at least 31 mm in length, or at least 32 mm in length. It is theorized that fatigue-induced failure of the NiTi file 50 occurs as a result of resonance effects caused by application of the ultrasonic energy, such that the ultrasonic energy excites the natural resonance frequency of the NiTi file, creating standing waves and resulting in much faster breakage than what occurs in stainless steel files. Such failure is believed to result from propagation of a fatigue-induced crack originating at defects in the NiTi material (e.g., inclusions, micro-fissures, etc.).

A typical NiTi file 50 may have a composition including from about 52 to about 60 (e.g., about 57) weight percent nickel and about 40 to about 48 (e.g., about 41) weight percent titanium. Other components may be included in some nickel-titanium super-elastic alloys e.g., the nickel-titanium alloy may be a nickel-titanium-chromium alloy, a nickel-titanium-copper alloy, or a nickel-titanium-niobium alloy. Any other super-elastic alloys may also be suitable for use in methods according to the present invention (e.g., even those that may not be based on nickel-titanium). Such super-elastic alloys may be cold worked to increase their stiffness. In some embodiments, the degree of cold working may retard or block super elastic behavior, strictly speaking (i.e., they may exhibit cold- work induced pseudo-elastic behavior rather than strict super-elastic behavior). Nevertheless, such cold-worked alloys are within the scope of the present invention and meaning of the term “super-elastic nickel-titanium alloys”, as employed herein.

The applied ultrasound energy may have a frequency that closely matches the natural resonance frequency of the NiTi material from which the endodontic file is formed. The applied ultrasonic energy may typically have a frequency in a range of about 25 kHz to about 35 kHz (e.g., about 28 kHz to about 30 kHz). The natural resonance frequency of typical NiTi alloys from which endodontic files are formed is believed to be about 27 kHz. It is believed that by increasing the exposed length 52 of file 50 (i.e., that portion that extends beyond the coupling chuck), the resonance effects are sufficiently reduced or otherwise retarded to increase the exposure time required to result in file breakage. In any case, the inventor has observed that longer exposed portion file lengths, particularly exposed portion lengths of at least 22 mm, exhibit significantly reduced file breakage as compared to shorter file lengths.

FIG. 4 shows a close up view of a connector 150 for coupling a NiTi endodontic file 50, which connector is coupleable to an ultrasonic powered handpiece 54. Connector 150 includes a chuck 152 at a distal end for coupling the NiTi endodontic file 50 into connector 150. File 50 and chuck 152 may include any suitable coupling mechanism for coupling file 150 into chuck 152. Illustrated connector 150 includes a threaded male insert 154 at a proximal end opposite chuck 152 that may be coupled into a distal end of an ultrasonic powered handpiece 54 (e.g., as seen in FIG. 3). Any desired coupling mechanism for coupling connector 150 with powered handpiece 54 may be employed. For example, connector 150 may include a male insert 154 receivable into a corresponding female receptacle disposed on the ultrasonic powered handpiece. In the illustrated embodiment, coupling threads are provided. Various other coupling mechanisms will be apparent to one of skill in the art. For example, in another embodiment, a female receptacle may be disposed at the proximal end of connector 150, while a corresponding male insert may be disposed on an end of the ultrasonic powered handpiece 54 to which connector 150 is to be coupled. In an embodiment, chuck 152 may be positioned within connector 150.

Illustrated connector 150 further comprises a central portion 156 between threaded male insert 154 or other coupling means and chuck 152. Central portion 156 may include an elbow bend 158 defining a proximal central portion 156a and a distal central portion 156b. The longitudinal axes of proximal central portion 156a and the coupling means at the proximal end (e.g., threaded male insert 154) may be substantially aligned with one another, while a longitudinal axis of distal central portion 156b may be angled to be substantially perpendicular relative to the longitudinal axis of chuck 152 and the NiTi endodontic file.

In addition to being affected by the length of the exposed portion of file 50, it is also believed that the angle provided between the longitudinal axis of the chuck (and file 50 received therein) and the distal central portion 156b of the connector (i.e., where the central portion intersects the chuck) may also have an effect on how quickly ultrasound energy induced failure of the NiTi endodontic file 50 occurs. In the illustrated configuration, this angle is perpendicular, or about 90°. In several embodiments, this angle may be within about 25° of perpendicular, within about 20° of perpendicular, within about 10° of perpendicular, within about 5° of perpendicular, or within about 3° of perpendicular.

The presence of elbow bend 158 within central portion 156 provides an angle between the coupling means (e.g., threaded male insert 154) and the NiTi endodontic file 50 that is different than the angle between file 50 and distal central portion 156b, as described above. For example, while the angle between distal central portion 156b and the Ni—Ti endodontic file 50 may be 90°, the angle between the Ni—Ti endodontic file 50 and the coupling means (e.g., threaded male insert 154) (and thus the ultrasonic powered handpiece) may be greater than 90° (e.g., about 110° , 115° , or 120°). In other words, in several embodiments, elbow bend 158 may provide an angle between proximal central portion 156a and distal central portion 156b that is from about 1° to about 45°, 5° to about 40°, or 10° to about 20°. Such an elbow bend 158 may assist the practitioner in providing a more ergonomic angle between the ultrasonic powered handpiece 54 gripped within the practitioner's hand and the NiTi endodontic file 50 inserted into the root canal 34 of the tooth 30, while providing an optimal angle between the NiTi endodontic file 50 and the distal portion 156b adjacent chuck 152, which may act to further lengthen the period of time available to the practitioner before the NiTi file 50 breaks.

Connector 150 advantageously includes means for adjusting the exposed portion length 52 of an inserted NiTi endodontic file 50. For example, coupling knob 160 may serve to open and close a chuck coupling mechanism within chuck 152, so that one may insert the NiTi endodontic file 50 to a deeper or more shallow degree within chuck 152, and then tighten knob 160 once a desired exposed portion length 52 of the NiTi file 50 is provided. Thus, for somewhat longer files (e.g., 27 mm or 30 mm files), the practitioner may seat the file more deeply within chuck 152 than for a relatively shorter file (e.g., 23 mm or 25 mm) For example, in order for a 25 mm file to provide an exposed portion of at least 22 mm, no more than 3 mm of the proximal end of the file shaft should be received within chuck 152. With a 30 mm file, as much as 8 mm of the proximal end of the file shaft could be received within chuck 152, while still providing at least 22 mm of exposed length. Of course, more than 22 mm may be exposed to provide even longer ultrasound working times before the NiTi file 50 would need to be removed.

The inventor has found that NiTi file 50 may be consistently employed with ultrasound for 3 1-minute cycles or more, 5 1-minute cycles or more, 8 1-minute cycles or more, or 10 1-minute cycles or more, without breakage occurring. 10 or more cycles may be possible with a 30 mm file (e.g., a 30-02 file). One may employ cycle times having a duration as desired. For example, one may employ a cycle time from about 30 seconds to about 2 minutes (e.g., 1 minute). One may desire to remove the NiTi file 50 in between cycles (e.g., to irrigate the canal to aid in debris removal, etc.). One may perform several cycles (e.g., 3 cycles, 5 cycles, 8 cycles, 10 cycles, 3-10 cycles, 3-8 cycles, etc.) to complete cleaning one or more particular portions of the root canal. The total working time during which ultrasonic energy is applied to the NiTi file may be monitored by the practitioner (or by the powered handpiece 54) to ensure that the file is removed and discarded before failure occurs. For example, one NiTi file may provide sufficient working time before failure when used in accordance with the presently described inventive methods. In another embodiment, one may elect to remove and discard the file after a certain period of use (e.g., after 3 minutes of cumulative use, 5 minutes of cumulative use, 8 minutes of cumulative use, or 10 minutes of cumulative use) and replace the NiTi file with a new file. “Time of use” as described above may refer to the time the file is exposed to ultrasonic energy, not counting any rest periods in between cycles.

In several embodiments, the NiTi endodontic files employed with the present methods may have an actual shaft length (e.g., typically measured from any enlarged head for coupling within chuck 152) that is at least 23 mm or at least 25 mm (e.g., 25 mm to 30 mm) The inventor has found that while NiTi endodontic files are available in shorter lengths (e.g., 15 and 20 mm), such files are too short, and break easily and quickly upon exposure to ultrasonic energy. Files that are at least somewhat longer provide sufficient length to allow them to be coupled into a chuck in a manner so that at least 22 mm of length is exposed, significantly lengthening the time provided before ultrasound induced failure occurs. Typical files may include a taper of 2% (e.g., −02 in the typical naming convention). Other tapers (or no taper) may alternative be provided.

The diameter of the NiTi endodontic file may also have an effect on achievable ultrasonic working time before failure occurs. For example, a larger diameter file may better resist breakage than a smaller diameter file. Where the diameter is sufficiently large, lower exposed lengths may be provided (e.g., between about 22 mm and about 23 mm, perhaps even less than 22 mm), while still providing sufficient working time (e.g., at least 3 minutes) to allow the practitioner to complete the desired procedure.

Exemplary NiTi files employed in the present methods may include, but are not limited to those having diameters of 0.08 mm, 0.1 mm, 0.15 mm, 0.2 mm, 0.25 mm, 0.3 mm, 0.35 mm, 0.4 mm, 0.45 mm, 0.5 mm, 0.55 mm, 0.6 mm, 0.7 mm, and 0.8 mm. Preferably, the diameter of the NiTi files may be greater than or equal to 0.25 mm. The files may have lengths of more than 20 mm, such as 23 mm, 25 mm, 27 mm, and 30 mm.

Any of various ultrasonic generators available for use with stainless steel files may be used. For example, a suitable ultrasonic generator is ENAC, available from Osada.

Another ultrasonic generator that may be employed is TIGON, available from W&H Dentalwerks. A connector similar to that shown in FIG. 4 is available from Osada under part number ST24.

Application of ultrasound energy to endodontic files can also “activate” debriding and cleaning agents. Cleaning and debriding agents work better when they are agitated because “fresh” or “non-reacted” material is caused to more intimately interact with the endodontic surfaces being treated. Ultrasonic vibration of both NiTi endodontic files and endodontic files made of other materials, such as stainless steel, can facilitate penetration of chemical agents into spaces, crevices and pores within a root canal.

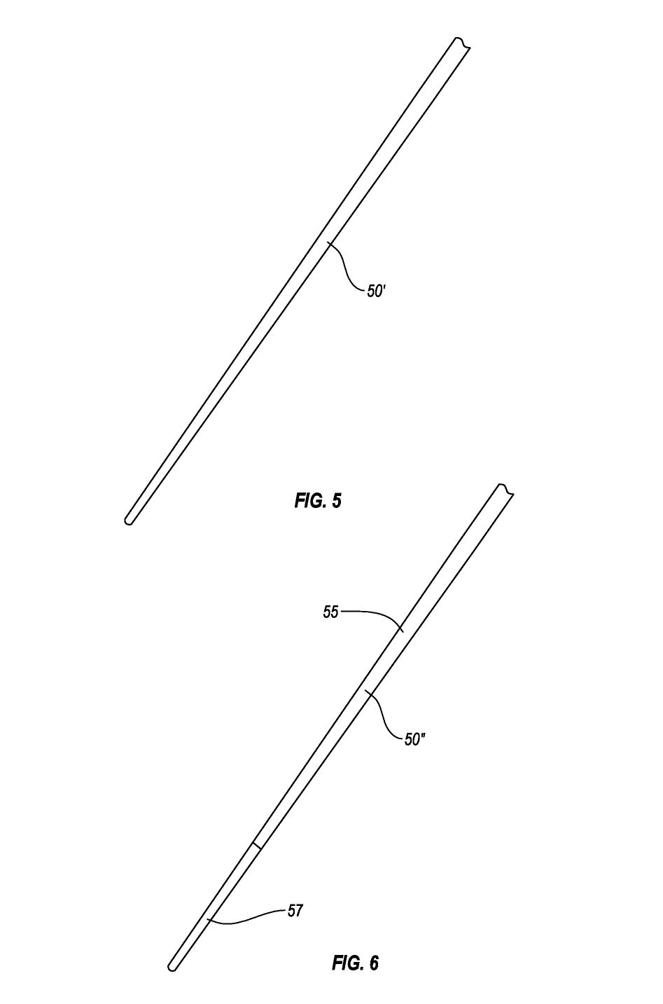

While FIGS. 2 and 4 show NiTi endodontic files 50 including cutting surfaces (e.g., flutes or other cutting surfaces) disposed along a distal working portion of the file, it will be understood that the described systems and methods may be employed with a NiTi instruments with other configurations. For example, FIG. 5 shows a smooth endodontic instrument 50′ which may not include cutting surfaces on a working portion thereof, but may be smooth along substantially its full working length. FIG. 6 shows another example of an endodontic instrument 50″ having a surface of the NiTi instrument that may be at least partially abraded by sandblasting, etching or another process. For example, the surface may be abraded along substantially its full working length or may have an abraded portion and a smooth distal tip having a length of between about 3 mm and about 6 mm and, more particularly, about 5 mm. Such embodiments (e.g., FIGS. 5 and 6) may resemble an ice pick. While such instruments may not be used to cut away tissue within the root canal, they may serve to break up and dislodge necrotic or other tissue within the root canal, and/or activate debriding, cleaning, or other agents introduced into the root canal, particularly when subjected to ultrasonic energy, providing high frequency vibration of instrument 50′ or 50″ within the root canal.

Because such an instrument does not include flutes or other cutting surfaces, it may exhibit less surface area as compared to a similarly sized instrument having cutting surfaces. Such a decreased surface area may limit surface exposure of inclusions or other imperfections within the NiTi material, making the instrument less likely to break. In other words, such an instrument may exhibit a lower density of surface imperfections that might serve to initiate and/or propagate breakage of the instrument. For purposes of simplicity, the term “endodontic file” as used herein is to be broadly construed to include such smooth instruments, as well as those including cutting edges or surfaces.

It will be appreciated that the powered handpieces 54 may move the endodontic files in any suitable mode (e.g., rotation, reciprocating rotational movement, etc.). Alternatively, the only movement of the file provided by the powered handpiece may be the high frequency vibration provided by the ultrasonic energy. Where desired, the practitioner may manually provide additional movement (e.g., up and down, rotational, reciprocating rotation, etc.) to the file within the root canal during use. Thus, there may be multiple sources of file movement applied during use.

A working example similar to that shown in FIG. 6 was tested. The tested endodontic instrument 50″ included a total length of 30 mm, and an exposed portion length 52 of 22 mm. The proximal portion 55 of the body of instrument 50″ was abraded (e.g., sandblasted, etched, etc.) to provide a roughened texture (e.g., similar to sandpaper), while the distal portion 57 of the body of instrument 50″ was smooth. Smooth distal portion 57 had a length of about 5 mm. Such an instrument was coupled into a chuck and powered using an ENDO-EZE® ARIOS® dental handpiece (Ultradent Products, Inc.). The dental handpiece was set to “6”. The NiTi tip was used to shape Endo-Training-Block simulators (Dentsply Maillefer). The Endo-Training-Block simulators had a taper of 0.02, an apex diameter of size #15 (0.15 mm), a 35° curvature, and a mean canal length of 18 mm. Time to damage or failure of the NiTi tip during shaping in the simulator was at least 3 minutes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for cleaning a root canal of a tooth, the method comprising:
inserting an endodontic file into a root canal of a tooth, the endodontic file including a working portion comprising a super-elastic nickel-titanium alloy;
cleaning the root canal by moving the working portion of the endodontic file within the root canal so that the working portion of the endodontic file cuts or abrades tissue within the root canal; and
applying ultrasonic energy to the endodontic file, tooth, or both in order to assist in breaking up and removing necrotic tissue in the root canal of the tooth, wherein application of ultrasonic energy does not result in breakage of the endodontic file for at least three minutes.

2. A method as recited in claim 1, wherein the endodontic file is coupled with a chuck of a powered handpiece assembly so that an exposed portion of the endodontic file extends beyond the chuck.

3. A method as recited in claim 2, wherein the exposed portion is at least 22 mm in length.

4. A method as recited in claim 2, wherein the exposed portion is at least 23 mm in length.

5. A method as recited in claim 2, wherein the exposed portion is at least 24 mm in length.

6. A method as recited in claim 2, wherein the endodontic file is coupled with a chuck of a powered handpiece assembly so that an angle between a longitudinal axis of the endodontic file and a longitudinal axis of a portion of the powered handpiece assembly that is proximal the chuck is about 90°.

7. A method as recited in claim 1, wherein the ultrasonic energy is applied to the endodontic file.

8. A method as recited in claim 1, wherein the ultrasonic energy results in high frequency vibration of the endodontic file within the root canal.

9. A method as recited in claim 1, wherein the ultrasonic energy has a frequency from about 25 kHz to about 35 kHz.

10. A method as recited in claim 1, wherein the ultrasonic energy has a frequency of about 30 kHz.

11. A method for cleaning a root canal of a tooth, the method comprising:
coupling an endodontic file into a chuck of a powered handpiece assembly so that an exposed portion of the endodontic file extends at least 22 mm beyond the chuck, the endodontic file including a working portion comprising a super-elastic nickel-titanium alloy;
inserting at least a portion of the exposed portion of the endodontic file into a root canal of a tooth;
cleaning the root canal by moving the working portion of the endodontic file within the root canal so that the working portion of the endodontic file cuts or abrades tissue within the root canal; and
applying ultrasonic energy to the endodontic file in order to assist in breaking up and removing necrotic tissue in the root canal of the tooth, wherein application of ultrasonic energy does not result in breakage of the endodontic file for at least three minutes.

12. A method as recited in claim 11, wherein the exposed portion is at least 23 mm in length.

13. A method as recited in claim 11, wherein the exposed portion is at least 24 mm in length.

14. A method as recited in claim 11, wherein the endodontic file is coupled within the chuck of a powered handpiece assembly so that an angle between a longitudinal axis of the endodontic file and a longitudinal axis of a portion of the powered handpiece assembly that is proximal the chuck is about 90°.

15. A system for use in a method for cleaning a root canal of a tooth employing a super-elastic nickel-titanium endodontic file and an ultrasonic powered handpiece, the system comprising:
a connector for use with an ultrasonic powered handpiece, the connector including a chuck at a distal end for coupling an endodontic file into the connector;
an endodontic file including a working portion comprising a super-elastic nickel-titanium alloy, the endodontic file being coupleable into the chuck of the connector so that an exposed portion of the endodontic file extending beyond the chuck is at least 22 mm in length when the endodontic file is coupled into the chuck.

16. A system as recited in claim 15, wherein the connector comprises means for coupling the connector to an ultrasonic powered handpiece at a proximal end, the connector further comprising a central portion between the coupling means at the proximal end and the chuck at a distal end of the connector.

17. A system as recited in claim 16, wherein when the endodontic file is coupled within the chuck, an angle between a longitudinal axis of the endodontic file and a longitudinal axis of the central portion adjacent the chuck is about 90°.

18. A system as recited in claim 16, wherein the central portion includes an elbow bend defining a proximal central portion and a distal central portion that are angled relative to one another, a longitudinal axis of the proximal central portion being substantially aligned with the coupling means at the proximal end, and a longitudinal axis of the distal central portion being substantially perpendicular to a longitudinal axis of the chuck.

19. A system as recited in claim 15, wherein the exposed portion is at least 22 mm in length when the endodontic file is coupled into the chuck.

20. A system as recited in claim 15, wherein the exposed portion is at least 24 mm in length when the endodontic file is coupled into the chuck.
